(19) United States
(12) Patent Application Publication
(10) Pub. No.: US 2025/0353425 A1
(43) Pub. Date: Nov. 20, 2025

(54) GUIDE AND SUPPORT BRACKET FOR TRUCK CAMPERS

(71) Applicant: NB4 Brand L.L.C. d/b/a The Kingstar Company, Chassell, MI (US)

(72) Inventors: Marcus Niemela, Houghton, MI (US); Michael R. Jackson, Hancock, MI (US)

(21) Appl. No.: 19/211,793

(22) Filed: May 19, 2025

Related U.S. Application Data
(60) Provisional application No. 63/649,446, filed on May 19, 2024.

(51) Int. Cl. B60P 3/36

(52) U.S. Cl. CPC B60P 3/36

(57) ABSTRACT

A guide and support bracket is positioned at opposite sides of a truck camper to provide a visual aid while a user is backing their truck toward the truck camper, to cause the truck camper to self-adjust its lateral alignment with the bed of the truck as the truck camper is lowered into its final mounting position at the bed of the truck, and to secure the truck camper against lateral movements in the truck bed while the truck is being driven and/or when the truck camper is in use.

### CROSS REFERENCE TO RELATED APPLICATION

The present application claims the benefit of U.S. provisional application Ser. No. 63/649,446, filed May 19, 2024, which is hereby incorporated herein by reference in its entirety.

### FIELD

The present invention relates to truck campers that are securable and removable from the beds of pickup trucks.

### BACKGROUND

Truck campers are structures providing portable living spaces, and are designed for mounting at the bed of a pickup truck having a bed between left and right sidewalls and a rear liftgate. The rear liftgate is typically lowered or removed when the bed is to be fitted with a truck camper. Truck campers typically have narrower lower portions and wider upper portions, which allows for a larger overall living space having a lower portion that fits between the sidewalls on either side of the truck bed, and the wider upper portion extending laterally over the sidewalls of the truck bed, and sometimes laterally beyond them. When truck campers are not mounted at the bed of a truck, they are typically supported above a ground surface for storage, such as by extendable and retractable jacks mounted at four corners of the truck camper. To install the truck camper at a pickup truck, the user will back their truck toward a forward end of the elevated truck camper while making efforts to align the moving truck bed with the stationary truck camper. Because of the size and location of the truck camper relative to the moving truck and truck bed during this process, it can be challenging to achieve and maintain good alignment of the truck bed and its sidewalls with the truck camper and jacks while backing the truck toward the camper, so that the truck camper's lower portion is received fully into the truck bed without inadvertently scraping or pushing the truck camper.

### SUMMARY

The present invention provides a guide and support bracket that can be placed at one or more corners (or all of the four corners) of a truck camper to provide both a visual aid while a user is backing their truck toward the truck camper, and to cause the truck camper to self-adjust its lateral alignment with the bed of the truck as the truck camper is lowered into its final mounting position at the bed of the truck.

According to one form, a guide and support bracket for truck campers includes a guide plate adjustably mounted to a lateral mounting plate. The lateral mounting plate is configured for securing to a truck camper, and it defines a guide for the guide plate. The guide plate is selectively securable to the lateral mounting plate at the guide, and is selectively movable laterally relative to the lateral mounting plate. A fastener is provided for coupling the guide plate to the lateral mounting plate, and it engages the guide of the lateral mounting plate. The guide plate has a downwardly-extending portion including an angled tab that extends laterally inwardly from top to bottom. When the bracket is coupled to a truck camper and the guide plate is secured to the lateral mounting plate, the downwardly-extending portion of the guide plate engages an inboard surface of a sidewall of a truck bed to align the truck camper with the truck bed.

In one aspect, the guide of the lateral mounting plate is in the form of a lateral slot, and the fastener is a threaded bolt and nut. Optionally, the guide of the lateral mounting plate has three of the lateral slots in parallel and vertically spaced arrangement relative to one another, and respective threaded bolts are disposed in each of the lateral slots with a respective threaded nut at each of the threaded bolts.

In another aspect, the angled tab is oriented at approximately 45 degrees relative to horizontal when the downwardly-extending portion of the guide plate is aligned vertically.

Therefore, the guide and support bracket facilitates backing a pickup truck into approximate alignment with a truck camper that is supported on jack stands, and further causes the truck camper to self-align into desired alignment as the truck camper is fully lowered into the truck bed by retracting the jack stands. These features facilitate one-person loading of the truck camper into the truck bed, and also can achieve a tight lateral fit of the truck camper in the truck bed so that the camper will not slide laterally in the bed during movement of the truck.

These and other objects, advantages, purposes and features of this invention will become apparent upon review of the following specification in conjunction with the drawings.

### BRIEF DESCRIPTION OF THE DRAWINGS

FIG. 1 is a front-left perspective view of a truck camper fitted with guide and support brackets;

FIG. 2 is a rear-right perspective view of the front left guide and support bracket of FIG. 1;

FIG. 3 is a front-left perspective view of a rear left guide and support bracket for use with the truck camper of FIG. 1;

FIGS. 4A-4C are a series of front-left perspective views of the truck camper of FIG. 1, shown fitted with rear guide and support brackets, and depicting a sequence of lowering steps for installing the truck camper in the bed of a pickup truck; and

FIG. 5 is a rear elevation view of the truck camper of FIG. 4C, shown fully lowered into the truck bed; and

FIG. 6 is another rear elevation view of the truck camper shown fully lowered into the truck bed.

### DESCRIPTION OF THE PREFERRED EMBODIMENTS

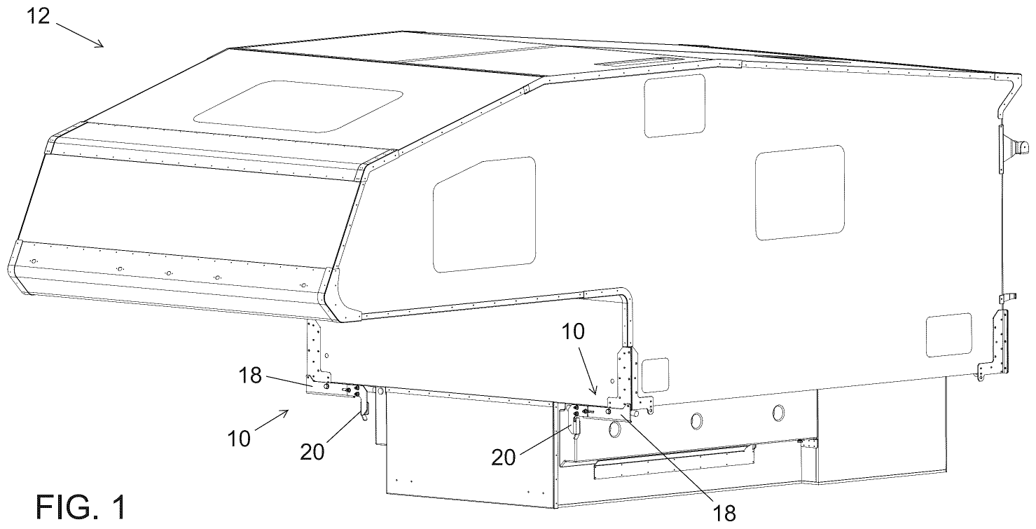

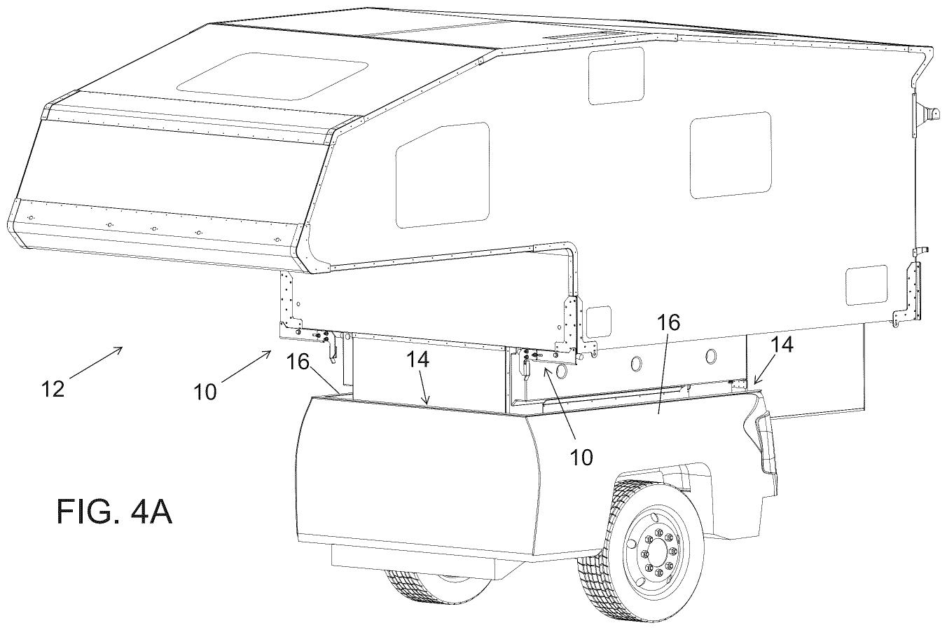

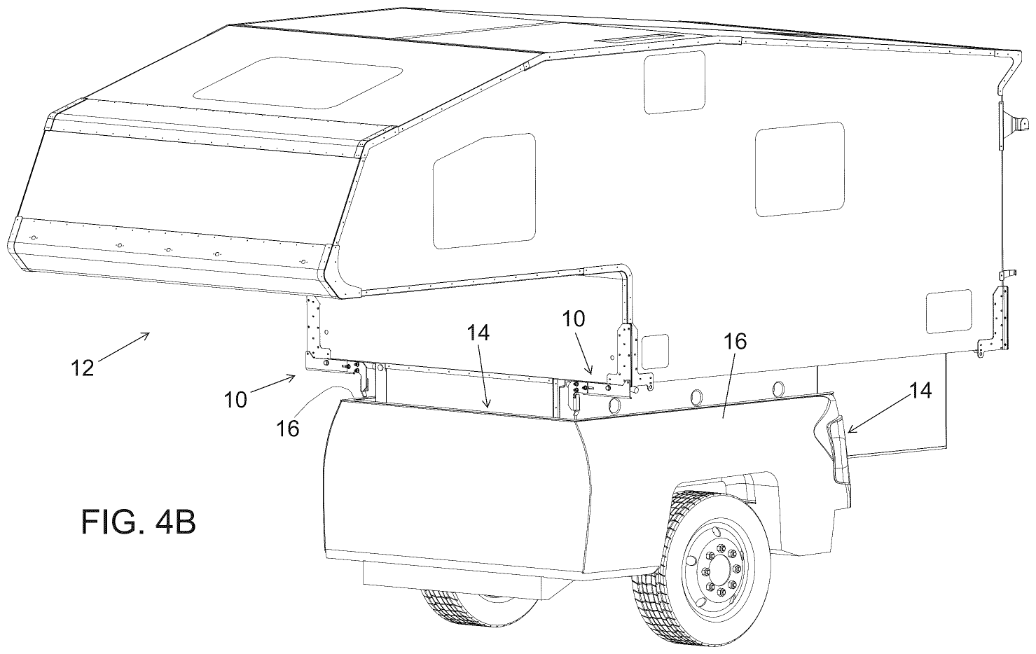

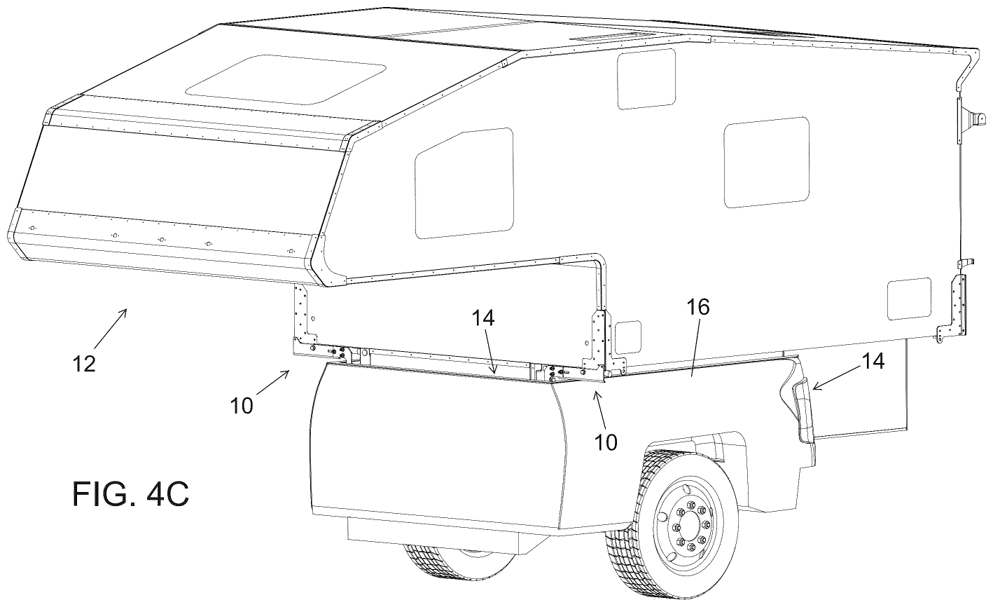

Referring now to the drawings and illustrative embodiments depicted therein, guide and support brackets 10 are coupled to the four lower corners of a truck camper 12, for guiding the truck camper 12 laterally as it is lowered into a truck bed 14, such as shown in FIGS. 1 and 4A-6. The brackets 10 are adjustable according to the width of truck bed 14 between left and right sidewalls 16 having inboard rails or surfaces 16a, so that in the event of minor misalignments the truck camper 12 will shift laterally into precise alignment with the truck bed 14 as the truck camper 12 is lowered into position at the truck bed 14, or as the truck bed 14 is raised into engagement with the truck camper 12. With the brackets 10 set to the width of the truck bed 14, the brackets also provide lateral stability of the truck camper 12 relative to the truck bed 14 by resisting lateral movements of the truck camper 12, such as during overland travel with the camper 12 secured to the truck bed 14. The brackets 10 also provide a visual guide for a driver of the truck, making it easier for the driver to see and visually assess the alignment of the truck bed 14 relative to the truck camper 12 as the driver backs and steers the truck toward the truck camper 12. This facilitates better alignment of the truck bed 14 relative to the truck camper 12 prior to lowering the camper 12 relative to the bed 14, which is depicted sequentially in FIGS. 4A-4C.

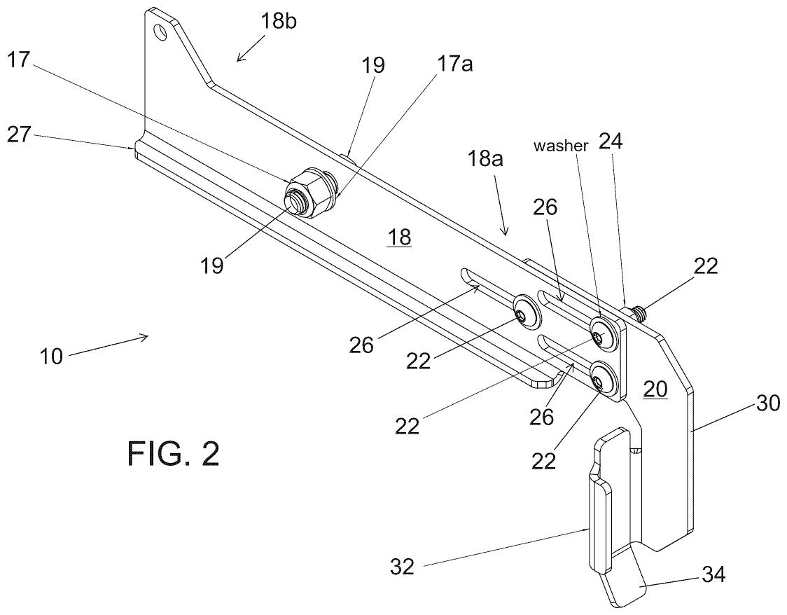

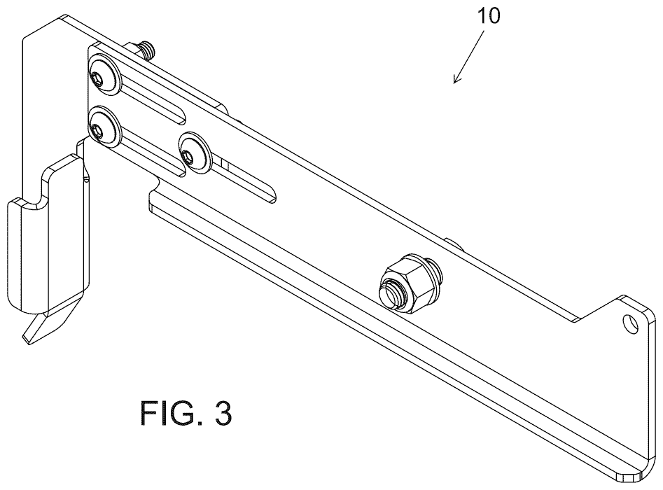

A front-left guide and support bracket 10 and a rear-left guide and support bracket 10 are shown in FIGS. 2 and 3, respectively. Although their shapes are slightly different, being essentially mirror images of one another, it will be appreciated that they are functionally the same as one another such that the same reference numerals are applied to each bracket and the description of one bracket applies equally to the other. Each guide and support bracket 10 includes a lateral mounting plate 18 that is designed to be secured to a front or rear outboard corner of the truck camper 12, such as with one or more threaded fasteners (one nut 17 and corresponding bolt 19 are shown). Each bracket 10 further includes a guide plate 20 that is selectively slidable and securable to the lateral mounting plate 18, such as with a plurality of threaded bolts 22 and corresponding threaded nuts 24. The lateral mounting plate 18 defines a plurality of horizontal slots 26 for receiving shafts of the bolts 22, and the guide plate 20 defines holes for also receiving shafts of the bolts 22. When nuts 24 are sufficiently tightened to bolts 22, the guide plate 20 is clamped to the mounting plate 18 so that the lateral position of guide plate 20 is fixed relative to mounting plate 18. When nuts 24 are loosened at bolts 22, the guide plate 20 may be slid laterally relative to mounting plate 18 to the extent that slots 26 permit the shafts of bolts 22 to traverse the length each slot 26. In the illustrated embodiment, lateral mounting plate 18 includes a lower lip 27 that may wrap beneath a lower edge of truck camper 12 to maintain proper alignment of the bracket 10 during installation and use, and to also protect corner edges of the truck camper 12. Optionally, heads of the bolts 22 have integral flanges or the bolts 22 are fitted with washers 29 having a greater width than the bolt heads, to facilitate tightening.

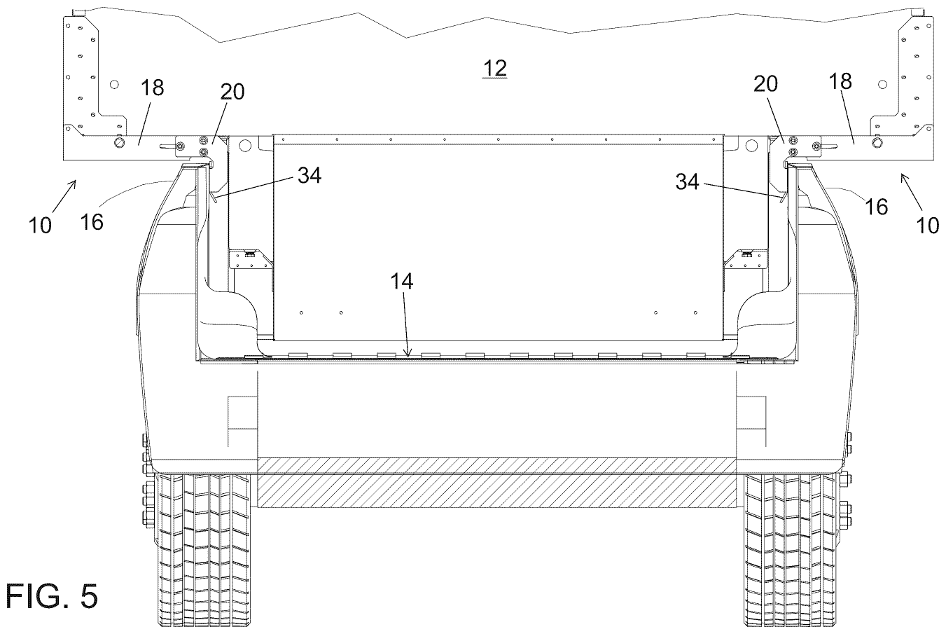

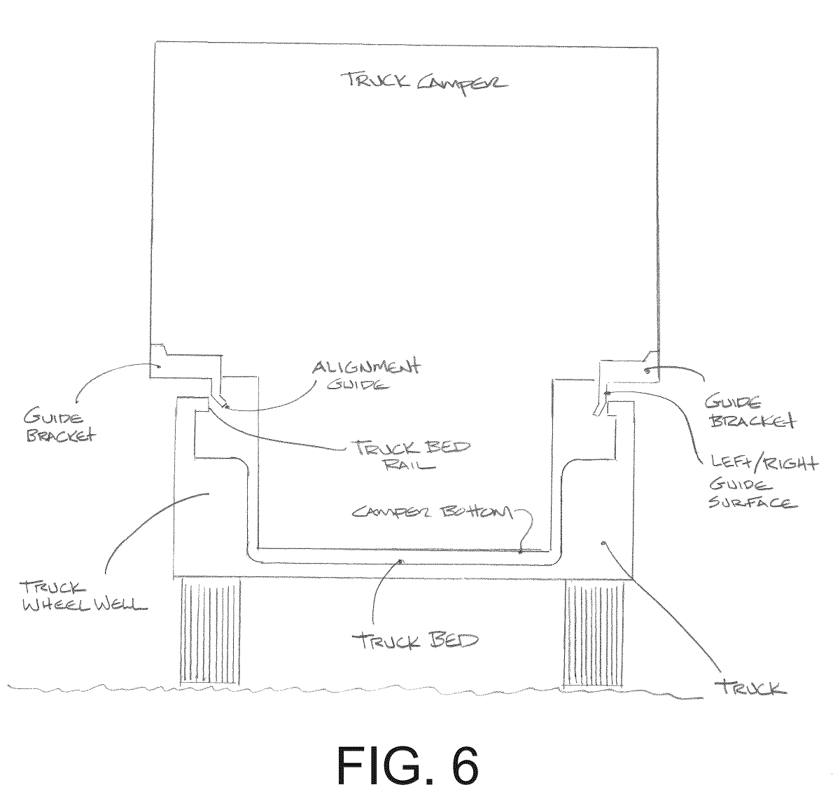

Guide plate 20 has a lateral portion 28 where bolts 22 are received, and a downwardly-extending portion 30 that includes a bed-abutting portion 32 and an angled bottom tab 34 extending laterally inwardly from top to bottom. In the illustrated embodiment, angled bottom tab 34 is set at approximately a 45 degree angle relative to horizontal when the downwardly-extending portion 30 of the guide plate 20 is oriented vertically. The dimensions and angle of angled bottom tab 34 may be chosen according to the application and the maximum lateral offset that is to be permitted for the camper 12 relative to sidewalls 16 before the camper 12 is lowered. Angled bottom tab 34 acts as a guide ramp if it contacts the upper-inboard edge or rail 16a at the top of sidewall 16 while the truck camper 12 is being lowered into the bed 14 as shown in FIGS. 4A-4C and 6, serving to deflect the truck camper 12 toward the center of the bed 14 so that the truck camper 12 is centered relative to the bed 14. The narrower lower region 12a of the camper will then fit between any wheel wells 31 in the bed 14, such as shown in FIG. 6. As the camper 12 is fully lowered (FIGS. 4C and 5) the bed-abutting portions 32 of the brackets 10 on opposite sides of the camper 12 will engage the inboard surfaces of the respective sidewalls 16 and secure the camper 12 against lateral movements relative to the bed 14. The camper 12 may then be fully secured to the truck in a conventional manner, usually with tensioned chains, cables, straps, or the like. In the illustrated embodiment, bed-abutting portions 32 also include a side tab 36 along a rear edge thereof. Side tabs 36 facilitate allowing the truck camper 12 to slide rearwardly with bed-abutting portions 32 engaging the inner rails 16a. A curved surface 38 transitions from the guide plate's downwardly-extending portion 30 to the bed-abutting portion 32, and serves to facilitate allowing the truck camper 12 to slide forwardly with bed-abutting portions 32 engaging the inner rails 16a.

In the illustrated embodiment, three slots 26 are arranged in vertically spaced and parallel alignment, with upper and lower slots positioned toward an inboard end 18a of lateral mounting plate 18, and a middle slot positioned closer to an outboard end 18b of lateral mounting plate 18. This arrangement allows the guide plate 20 to maintain the same alignment with lateral mounting plate 18 regardless of whether the nuts 24 are tightened to threaded bolts 22, and regardless of the position of guide plate 20 relative to mounting plate 18. The lengths of the slots 26 determine the lateral adjustability of guide plate 20 relative to mounting plate 18, and it will be appreciated that these and other dimensions may be limited according to the range of sizes of truck camper 14 and truck bed 12.

Prior to the first mounting of the truck camper 12 fitted with brackets 10 to the truck bed 14, a user may first take a measurement of the interior distance between the truck's sidewall rails 16a at front and/or back. This measurement is then used as a reference when adjusting the guide plates 20 at each side of the camper 12 until the distance between the bed-abutting portions 32 is approximately the same as or less than the distance between the sidewall rails 16a where the brackets 10 will be located once the truck camper 12 is positioned in the bed 14. If a guide plate 20 at one side of the camper 12 extends outwardly by a different distance than the corresponding guide plate 20 at the opposite side, both guide plates may be slid the same distance in the same direction until they extend outwardly by the same distance with the distance between the bed-abutting portions 32 still matching the distance between the sidewall rails 16a. Optionally, the guide plates 20 may be set with bed-abutting portions 32 slightly further apart than the distance between sidewalls 16 to provide an interference or tight fit, possibly deflecting the sidewalls 16 slightly outwardly during the camper lowering process of FIGS. 4A-4C. Once the desired positions of guide plates 20 are set, the nuts 24 are tightened on the respective bolts 22. The brackets 10 are then set for that particular combination of bed 14 and camper 12, and will not require further adjustment unless the camper 12 is to be fitted to a different truck in the future.

The truck is then backed into position relative to the truck camper 12 using the downwardly-extending portions 30 of guide plates 20 as a visual reference for the lateral position of camper 12 relative to the sidewall rails 16a. Optionally, forward surfaces of the downwardly-extending portions 30 may be brightly colored or coated with light-reflective material to facilitate viewing them in the truck's side-view mirrors and/or in low-light conditions. The driver need only look at one side of the truck bed 14 and camper 12 to determine that the camper 12 is sufficiently aligned with the bed 14. This is because once the guide plates 20 are set and fixed in their desired positions as described above, the sufficient lateral alignment of one side of the camper 12 relative to one sidewall 16 results in sufficient lateral alignment of the other side of camper 12 relative to the opposite sidewall 16.

Sufficient alignment is achieved once the lower edge of one of the angled bottom tabs 34 is at least slightly laterally inboard of the inboard top edge of the corresponding sidewall 16. However, it may be considered sufficient alignment to leave the lower edge of one of the angled bottom tabs 34 even somewhat outboard of the inboard top edge or rail 16a of the corresponding sidewall 16, such as if the user is able to manually push and shift the truck camper 12 a sufficient distance laterally while it remains supported on jack stands, as the jack stands are retracted to lower the truck camper 12 into the bed 14. When four brackets 10 are used, one at each lower corner of the lower portion of the truck camper 12, the forward and rearward brackets 10 should both be aligned with the sidewall in this manner to ensure that both front and back ends of the camper 12 are sufficiently aligned without excessive yaw (rotation about a vertical axis) of the camper 12 relative to the bed 14.

Accordingly, the guide and support brackets facilitate proper alignment of a truck camper with a truck bed without trial-and-error, and by a single user who may remain in the truck during a camper-loading operation. The support brackets can be adjusted at set to ensure proper alignment of the truck camper in the truck bed once initial alignment has been achieved, and the support brackets facilitate initial alignment by providing a visual reference for the driver of the truck, since the support brackets include tabs that are easily seen by the driver and provide a visual reference aid for judging the lateral position of the truck camper to the truck's bed as the truck is backed into position relative to the truck camper resting on jack stands.

Changes and modifications in the specifically described embodiments can be carried out without departing from the principles of the present invention which is intended to be limited only by the scope of the appended claims, as interpreted according to the principles of patent law including the doctrine of equivalents.

1. A guide and support bracket for truck campers, said bracket comprising:
a lateral mounting plate configured for securing to a truck camper, said lateral mounting plate defining a guide;
a guide plate selectively securable to said lateral mounting plate at said guide, and selectively movable laterally relative to said lateral mounting plate;
a fastener for selectively coupling said guide plate to said lateral mounting plate, wherein said fastener engages said guide of said lateral mounting plate; and
said guide plate comprising a downwardly-extending portion including an angled tab that extends laterally inwardly from top to bottom;
wherein when said bracket is coupled to a truck camper and said guide plate is secured to said lateral mounting plate, said downwardly-extending portion engages an inboard surface of a sidewall of a truck bed to align the truck camper with the truck bed.

2. The bracket of claim 1, wherein said guide of said lateral mounting plate comprises a lateral slot and said fastener comprises a threaded bolt and nut.

3. The bracket of claim 2, wherein said guide of said lateral mounting plate comprises three of said lateral slots in parallel and vertically spaced arrangement relative to one another, and said fastener comprises one of said threaded bolts disposed in each of said lateral slots and a respective threaded nut at each of said threaded bolts.

4. The bracket of claim 1, wherein said angled tab is oriented at approximately 45 degrees relative to horizontal when said downwardly-extending portion of said guide plate is aligned vertically.
